(19) United States
(12) Patent Application Publication
(10) Pub. No.: US 2019/0024222 A1
(43) Pub. Date: Jan. 24, 2019

(54) STEEL WIRE FOR NON-HEAT TREATED MACHINE PART AND NON-HEAT TREATED MACHINE PART

(71) Applicant: NIPPON STEEL & SUMITOMO METAL CORPORATION, Tokyo (JP)

(72) Inventors: Makoto OKONOGI, Tokyo (JP); Daisuke HIRAKAMI, Tokyo (JP); Naoki MATSUI, Tokyo (JP)

(73) Assignee: NIPPON STEEL & SUMITOMO METAL CORPORATION, Tokyo (JP)

(21) Appl. No.: 16/069,246

(22) PCT Filed: Jan. 16, 2017
(86) PCT No.: PCT/JP2017/001287

§ 371 Date: Jul. 11, 2018

(30) Foreign Application Priority Data
Jan. 15, 2016 (JP) 2016-006378

(51) Int. Cl. C22C 38/32; C22C 38/28; C22C 38/26; C22C 38/24; C22C 38/06; C22C 38/04; C22C 38/02; C22C 38/00; C22C 38/14; F16B 33/00

(52) U.S. Cl. CPC C22C 38/32; C22C 38/28; C22C 38/26; C22C 38/24; C22C 38/06; F16B 33/00; C22C 38/02; C22C 38/002; C22C 38/001; C22C 38/14; C22C 38/04

(57) ABSTRACT

A steel wire for non-heat treated machine parts, the steel wire contains, based on % by mass: C: from 0.20 to 0.40%, Si: from 0.05 to 0.50%, Mn: from 0.50 to 2.00%, Al: from 0.005 to 0.050%, and the balance being Fe and impurities, in which the microstructure contains bainite of (35×[C %]+50)% or more, and when the diameter is defined as D, the average aspect ratio of a bainite grain at a depth of 50 μm in the L cross section is defined as AR, and the average grain size of a bainite grain at a depth of 50 μM in the C cross section is defined as GD, AR is 1.4 or more, (AR)/(the average aspect ratio of a bainite grain at a depth of 0.25D in the L cross section) is 1.1 or more, GD is (15/AR) μm or less, and (GD)/(the average grain size of a bainite grain at a depth of 0.25D in the C cross section) is less than 1.0.

### TECHNICAL FIELD

This disclosure relates to a steel wire for non-heat treated machine parts and a non-heat treated machine part.

### BACKGROUND ART

In recent years, in the fields of a variety of machines such as automobiles, constructions and the like, from the viewpoint of weight saving or space saving, needs for high strength machine parts are increasing.

However, as the strength of a high strength machine part increases, particularly when the tensile strength of the high strength machine part is 1,100 MPa or more, destruction due to hydrogen embrittlement tends to occur (in other words, hydrogen embrittlement resistance tends to be lowered).

As a method of improving hydrogen embrittlement resistance of a high strength machine part, a method of strengthening the structure by wire drawing with a structure of pearlite structure is known, and many proposals have been made so far (see, for example, Patent Documents 1 to 11).

For example, Patent Document 11 discloses a high-strength bolt having a tensile strength of 1,200 MPa or more, which is obtained by forming a pearlite structure and then being subjected to wire drawing.

Patent Document 3 discloses a wire rod having a pearlite structure for a high-strength bolt having a tensile strength of 1,200 MPa or more.

Patent Document 1: Japanese Patent Application Laid-Open (JP-A) No. S54-101743

Patent Document 2: JP-A No. H11-315348

Patent Document 3: JP-A No. H11-315349

Patent Document 4: JP-A No. 2000-144306

Patent Document 5: JP-A No. 2000-337332

Patent Document 6: JP-A No. 2001-348618

Patent Document 7: JP-A No. 2002-069579

Patent Document 8: JP-A No. 2003-193183

Patent Document 9: JP-A No. 2004-307929

Patent Document 10: JP-A No. 2005-281860

Patent Document 11: JP-A No. 2008-261027

### SUMMARY OF INVENTION

### Problems to be Solved by the Invention

A high strength machine part with a tensile strength of 1,100 MPa or more is manufactured by subjecting a steel material of alloy steel in which an alloy element such as Mn, Cr, or Mo is added to carbon steel for machine structure to hot rolling, then spheroidizing annealing to soften the steel material, then shaping the steel material into a predetermined shape by cold working (such as cold forging or rolling), and then imparting strength to the material by quenching and tempering.

However, in the steel material of the alloy steel described above, the content of alloy elements is sometimes high, and in this case, the steel material price is high. In the manufacturing method described above, since softening annealing before molding and quenching and tempering after molding are required, manufacturing costs increases.

Under such circumstances, as a technique for reducing manufacturing costs, a technique of omitting softening annealing and quenching and tempering, and applying a predetermined strength by wire drawing to a wire rod whose strength has been increased by rapid cooling, precipitation strengthening, or the like is known.

This technique is utilized for manufacturing a machine part, and a machine part (such as a bolt) manufactured by utilizing this technique is called a non-heat treated machine part (such as a non-heat treated bolt).

A non-heat treated machine part having a tensile strength of 1,100 MPa or more can be manufactured by cold working a steel wire having a tensile strength of 900 MPa or more.

The hydrogen embrittlement resistance of a high strength machine part having a tensile strength of 1,100 MPa or more is improved to some extent by a technique of drawing a pearlite structure.

However, with these conventional techniques, as the strength of a steel wire for obtaining a high strength machine part increases by cold working, particularly in cases in which the tensile strength of the steel wire is 900 MPa or more, the cold workability when cold working the steel wire to obtain a high strength machine part may be deteriorated.

Due to the circumstances described above, it may be difficult for a steel wire with a tensile strength of 900 MPa or more for obtaining a high strength machine part having a tensile strength of 1,100 MPa or more to satisfy both cold workability when manufacturing a non-heat treated machine part by cold working and hydrogen embrittlement resistance when the wire is made into a non-heat treated machine part.

Accordingly, an object of the present disclosure is to provide a steel wire for non-heat treated machine parts excellent in cold workability when manufacturing a non-heat treated machine part by cold working and excellent in hydrogen embrittlement resistance when the wire is made into a non-heat treated machine part while being a steel wire having a tensile strength of 900 MPa or more.

An object of the disclosure is to provide a non-heat treated machine part that can be manufactured using a steel wire excellent in cold workability and is excellent in tensile strength and hydrogen embrittlement resistance.

### Means for Solving the Problems

Means for solving the above-described problems includes the following aspects.

<1> A steel wire for non-heat treated machine parts, the steel wire having a chemical composition, based on % by mass, of:
C: from 0.20 to 0.40%,
Si: from 0.05 to 0.50%,
Mn: from 0.50 to 2.00%,
Al: from 0.005 to 0.050%,
P: from 0 to 0.030%,
S: from 0 to 0.030%,
N: from 0 to 0.0050%,
Cr: from 0 to 1.00%,
Ti: from 0 to 0.050%,
Nb: from 0 to 0.05%,
V: from 0 to 0.10%,
B: from 0 to 0.0050%,
O: from 0 to 0.0030%, and
a balance being Fe and impurities, wherein:

a microstructure is composed of bainite having an area ratio of (35×[C %]+50)% or more, % by mass of C being defined as [C %], and a balance being at least one of proeutectoid ferrite or pearlite,

in a case in which a cross section parallel to an axial direction of the steel wire and including a central axis is defined as an L cross section, a cross section perpendicular to the axial direction of the steel wire is defined as a C cross section, a diameter of the steel wire is defined as D, an average aspect ratio of a bainite grain measured at a depth of 50 μm from a steel wire surface in the L cross section is defined as AR, and an average grain size of a bainite grain measured at a depth of 50 μm from the steel wire surface in the C cross section is defined as GD, AR is 1.4 or more, (AR)/(an average aspect ratio of a bainite grain measured at a depth of 0.25D from the steel wire surface in the L cross section) is 1.1 or more, GD is (15/AR) pm or less, and (GD)/(an average grain size of a bainite grain measured at a depth of 0.25D from the steel wire surface in the C cross section) is less than 1.0, and a tensile strength is from 900 to 1,500 MPa.

<2> The steel wire for non-heat treated machine parts according to <1>, containing, based on % by mass, one, or two or more of:
Cr: more than 0 and 1.00% or less,
Ti: more than 0 and 0.050% or less,
Nb: more than 0 and 0.05% or less,
V: more than 0 and 0.10% or less, or
B: more than 0 and 0.0050% or less.

<3> The steel wire for non-heat treated machine parts according to <1> or <2>, wherein D is from 3 to 30 mm.

<4> The steel wire for non-heat treated machine parts according to any one of <1> to <3>, wherein a critical compression ratio is 75% or more.

<5> A non-heat treated machine part, comprising a cylindrical shaft, the non-heat treated machine part having a chemical composition, based on % by mass, of:
C: from 0.20 to 0.40%,
Si: from 0.05 to 0.50%,
Mn: from 0.50 to 2.00%,
Al: from 0.005 to 0.050%,
P: from 0 to 0.030%,
S: from 0 to 0.030%,
N: from 0 to 0.0050%,
Cr: from 0 to 1.00%,
Ti: from 0 to 0.050%,
Nb: from 0 to 0.05%,
V: from 0 to 0.10%,
B: from 0 to 0.0050%,
O: from 0 to 0.0030%, and
a balance being Fe and impurities, wherein:

a microstructure is composed of bainite having an area ratio of (35×[C %]+50)% or more, % by mass of C being defined as [C %], and a balance being at least one of proeutectoid ferrite or pearlite,

in a case in which a cross section parallel to an axial direction of the cylindrical shaft and including a central axis is defined as an L cross section, a cross section perpendicular to the axial direction of the cylindrical shaft is defined as a C cross section, a diameter of the cylindrical shaft is defined as D, an average aspect ratio of a bainite grain measured at a depth of 50 μm from a cylindrical shaft surface in the L cross section is defined as AR, and an average grain size of a bainite grain measured at a depth of 50 μm from the cylindrical shaft surface in the C cross section is defined as GD, AR is 1.4 or more, (AR)/(an average aspect ratio of a bainite grain measured at a depth of 0.25D from the cylindrical shaft surface in the L cross section) is 1.1 or more, GD is (15/AR) μm or less, and (GD/an average grain size of a bainite grain measured at a depth of 0.25D from the cylindrical shaft surface in the C cross section) is less than 1.0, and

a tensile strength of the cylindrical shaft is from 1,100 to 1,500 MPa.

<6> The non-heat treated machine part according to <5>, containing, based on % by mass, one, or two or more of:
Cr: more than 0 and 1.00% or less,
Ti: more than 0 and 0.050% or less,
Nb: more than 0 and 0.05% or less,
V: more than 0 and 0.10% or less, or
B: more than 0 and 0.0050% or less.

<7> A non-heat treated machine part, which is a cold-worked product of the steel wire for non-heat treated machine parts according to any one of <1> to <4>, comprising a cylindrical shaft, wherein a tensile strength of the cylindrical shaft is from 1,100 to 1,500 MPa.

<8> The non-heat treated machine part according to any one of <5> to <7>, which is a non-heat treated bolt.

### Effects of the Invention

According to the disclosure, a steel wire for non-heat treated machine parts excellent in cold workability when manufacturing a non-heat treated machine part by cold working and excellent in hydrogen embrittlement resistance when the wire is made into a non-heat treated machine part while being a steel wire having a tensile strength of 900 MPa or more is provided.

According to the disclosure, a non-heat treated machine part that can be manufactured using a steel wire excellent in cold workability and is excellent in tensile strength and hydrogen embrittlement resistance is provided.

### BRIEF DESCRIPTION OF DRAWING

FIG. 1 is a conceptual diagram showing an example of a bainite grain in an L cross section of a steel wire of the disclosure.

### MODE FOR CARRYING OUT THE INVENTION

In the present specification, the numerical range expressed by using “from A to B” means a range including numerical values A and B as a lower limit value and an upper limit value.

In the present specification, “%” indicating the content of a component (element) means “% by mass”.

In the present specification, the content of C (carbon) may be referred to as “C content” in some cases. The content of other elements may also be indicated similarly.

In the present specification, the term “process” includes not only an independent process but also a case where an intended purpose of the process can be achieved even when the process can not be clearly distinguished from another process.

[Steel Wire for Non-Heat Treated Machine Part]

A steel wire for non-heat treated machine parts (hereinafter, also simply referred to as “steel wire”) of the disclosure has a chemical composition, based on % by mass, of C: from 0.20 to 0.40%, Si: from 0.05 to 0.50%, Mn: from 0.50 to 2.00%, Al: from 0.005 to 0.050%, P: from 0 to 0.030%, 5: from 0 to 0.030%, N: from 0 to 0.0050%, Cr: from 0 to 1.00%, Ti: from 0 to 0.050%, Nb: from 0 to 0.05%, V: from 0 to 0.10%, B: from 0 to 0.0050%, O: from 0 to 0.0030%, and the balance: Fe and impurities,

the microstructure is composed of bainite having an area ratio of (35×[C %]+50)% or more where the % by mass of C is defined as [C %] and the balance which is at least one of proeutectoid ferrite or pearlite,

in a case in which a cross section parallel to the axial direction of the steel wire and including the central axis is defined as an L cross section, a cross section perpendicular to the axial direction of the steel wire is defined as a C cross section, the diameter of the steel wire is defined as D, the average aspect ratio of a bainite grain measured at a depth of 50 μm from the steel wire surface in the L cross section is defined as AR, and the average grain size of a bainite grain measured at a depth of 50 μm from the steel wire surface in the C cross section is defined as GD, AR is 1.4 or more, (AR)/(the average aspect ratio of a bainite grain measured at a depth of 0.25D from the steel wire surface in the L cross section) is 1.1 or more, GD is (15/AR) μm or less, and (GD)/(the average grain size of a bainite grain measured at a depth of 0.25D from the surface of the steel wire in the C cross section) is less than 1.0, and

the tensile strength is from 900 to 1,500 MPa.

Although the steel wire of the disclosure is a steel wire having a tensile strength of 900 MPa or more, the steel wire is excellent in cold workability (hereinafter, also simply referred to as “cold workability”) when manufacturing a non-heat treated machine part by cold working.

Further, the steel wire of the disclosure is excellent in hydrogen embrittlement resistance (hereinafter, also simply referred to as “hydrogen embrittlement resistance”) when the steel is made into a non-heat treated machine part. In other words, by cold working the steel wire of the disclosure, a non-heat treated machine part having excellent hydrogen embrittlement resistance can be manufactured.

In the steel wire of the disclosure, the chemical composition described above contributes to both cold workability and hydrogen embrittlement resistance. Details of the chemical composition will be described below.

In general, in a steel wire of a chemical composition having a low C content (in particular, the C content is from 0.20 to 0.40%) as in the above-described chemical composition, proeutectoid ferrite is likely to be produced. For this reason, the microstructure of a steel wire having such a chemical composition tends to be a microstructure mainly composed of a two-phase structure of proeutectoid ferrite and pearlite. However, a microstructure mainly composed of two-phase structure of proeutectoid ferrite and pearlite has low cold workability and hydrogen embrittlement resistance.

Regarding this point, the microstructure of the steel wire of the disclosure is a microstructure mainly composed of bainite, and more specifically, the microstructure of the steel wire of the disclosure is a microstructure having an area ratio of bainite of (35×[C %]+50)% or more. As a result, the cold workability and hydrogen embrittlement resistance are improved.

In the disclosure, the reason why the area ratio of bainite depends on [C %] (or C content) is that in the C content range of from 0.20 to 0.40%, the proeutectoid ferrite is more likely to be produced as the C content is lower, and bainite tends not to be formed

In the steel wire of the disclosure, the average aspect ratio (or “AR” in the present specification) of a bainite grain measured at a depth of 50 μm from the steel wire surface in the L cross section is 1.4 or more, and (AR)/(the average aspect ratio of a bainite grain measured at a depth of 0.25D from the steel wire surface in the L cross section) is 1.1 or more.

In the present specification, a position at a depth of 50 μm from the steel wire surface is sometimes referred to as “50 p.m depth position” or “surface layer”. In other words, the “surface layer” in this specification means a position at a depth of 50 μm from the steel wire surface.

In the present specification, a position at a depth of 0.25D from the steel wire surface (or a position at which the depth from the steel wire surface is 0.25 times the diameter of the steel wire (or D) is sometimes referred to as “depth 0.25D position” or “0.25D”.

In the present specification, (AR)/(the average aspect ratio of a bainite grain measured at a depth of 0.25D from the steel wire surface in L cross section) is sometimes referred to as “ratio of aspect ratios [surface layer/0.25D]” of a bainite grain.

In the steel wire of the disclosure, the ratio of the aspect ratios [surface layer/0.25D] is 1.1 or more. In other words, in the L cross section of the steel wire of the disclosure, a bainite grain in the surface layer of the steel wire (or at a depth of 50 pm) is elongated more than a bainite grain inside the steel wire (or a depth of 0.25D position).

In the L cross section of the steel wire of the disclosure, the average aspect ratio (or AR) of a bainite grain in the surface layer is 1.4 or more.

In the steel wire of the disclosure, by satisfying these conditions, hydrogen embrittlement resistance (or hydrogen embrittlement resistance when formed as a non-heat treated machine part by cold working) is improved. The reason for this is believed to be that an elongated bainite grain in the surface layer becomes resistant to hydrogen ingress from the steel wire surface and/or resistance to crack propagation.

In the steel wire of the disclosure, the average particle diameter (GD) of a bainite grain measured at a depth of 50 μm in the C cross section is (15/AR) pm or less, and (GD)/(the average grain size of a bainite grain measured at a depth of 0.25D in the C cross section) is less than 1.0.

In the present specification, (GD)/(the average grain size of a bainite grain measured at 0.25D depth in the C cross section) is sometimes referred to as “grain size ratio [surface layer/0.25D]” of a bainite grain.

In the steel wire of the disclosure, the ratio of the grain sizes of bainite grains [surface layer/0.25D] is less than 1.0. In other words, in the C cross section of the steel wire of the disclosure, a bainite grain in the surface layer of the steel wire (or at the depth of 50 μm) are finer than a bainite grain inside the steel wire (or at the depth of 0.25D).

In the C cross section of the steel wire of the disclosure, the average particle diameter (or GD) of a bainite grain in the surface layer is (15/AR) pm or less.

In the steel wire of the disclosure, by satisfying these conditions, the cold workability of the steel wire is improved and hydrogen embrittlement resistance (or hydrogen embrittlement resistance when the steel wire is made into a non-heat treated machine part by cold working) is improved.

The reason why the cold workability of the steel wire is improved by satisfying the above conditions is considered to be due to the fact that a bainite grain in the surface layer is fine (or (15/AR) μm or less), thereby improving the ductility of the steel wire.

The reason why hydrogen embrittlement resistance is improved by satisfying the above conditions is considered to be related to the fact that a bainite grain in the surface layer is fine and that hydrogen tends to segregate at the crystal grain boundary. In other words, the reason is considered that, as the bainite grain in the surface layer is fine, the total area of grain boundaries in the surface layer is increased, and as a result, the hydrogen trapping capacity (or ability to prevent hydrogen from penetrating into a steel wire) in the surface layer is improved.

The steel wire of the disclosure has a tensile strength of from 900 to 1,500 MPa.

The steel wire of the disclosure (or a steel wire for non-heat treated machine part) having a tensile strength of from 900 to 1,500 MPa is suitable for manufacturing a non-heat treated machine part having a tensile strength of from 1,100 to 1,500 MPa by cold working.

The cold working in the disclosure is not particularly limited, and examples thereof include cold forging, rolling, cutting, and drawing.

The cold working in the disclosure may be only one kind of processing or a plurality of kinds of processing (for example, cold forging and rolling).

The non-heat treated machine part having a tensile strength of from 1,100 to 1,500 MPa may be manufactured by cold working the steel wire of the disclosure and then keeping the steel wire within a temperature range of from 100 to 400° C.

Since the steel wire of the disclosure is mainly composed of bainite and also satisfies the above-described conditions, while this steel wire has a tensile strength of 900 MPa or more, it is excellent in cold workability when obtaining a non-heat treated machine part by cold working.

In contrast to the steel wire of the disclosure, a steel wire having a tensile strength of 900 MPa or more and mainly containing pearlite, and a steel wire mainly having a proeutectoid ferrite-pearlite two-phase structure and having a tensile strength of 900 MPa or more tend to have low cold workability.

<Chemical Composition>

Next, the chemical composition of the steel wire of the disclosure will be described.

The chemical composition of a non-heat treated machine part of the disclosure, which will be described below, is also similar to the chemical composition of the steel wire of the disclosure.

Hereinafter, the chemical composition of the steel wire or the non-heat treated machine part of the disclosure is sometimes referred to as “chemical composition in the disclosure”.
C: From 0.20 to 0.40%

C is an element necessary for securing the tensile strength.

When the C content is less than 0.20%, it is difficult to obtain a desired tensile strength. Therefore, the C content in the chemical composition in the disclosure is 0.20% or more, and preferably 0.25% or more.

On the other hand, when the C content exceeds 0.40%, cold workability deteriorates. Therefore, the C content in the chemical composition in the disclosure is 0.40% or less, preferably 0.35% or less.
Si: From 0.05 to 0.50%

Si is an element for increasing the tensile strength by solid solution strengthening as well as a deoxidizing element.

When the Si content is less than 0.05%, an effect of adding Si is not sufficiently exhibited. Accordingly, the Si content in the chemical composition in the disclosure is 0.05% or more, and preferably 0.15% or more.

On the other hand, when the Si content exceeds 0.50%, an effect of addition is saturated, and ductility during hot rolling is deteriorated and flaws are likely to occur. Accordingly, the Si content in the chemical composition in the disclosure is 0.50% or less, and preferably 0.30% or less.
Mn: From 0.50 to 2.00%

Mn is an element for increasing the tensile strength of steel.

When the Mn content is less than 0.50%, an effect of addition is not sufficiently exhibited. Accordingly, the Mn content in the chemical composition in the disclosure is 0.50% or more, and preferably 0.70% or more.

On the other hand, when the Mn content exceeds 2.00%, the addition effect is saturated, the transformation completion time in an isothermal transformation treatment of a wire rod becomes long, and the manufacturability deteriorates. Accordingly, the Mn content in the chemical composition in the disclosure is 2.00% or less, and preferably 1.50% or less.
Al: From 0.005 to 0.050%

Al is a deoxidizing element, and is an element that forms AN functioning as a pinning particle. AIN reduces the grain size of the steel, thereby increasing the cold workability. Al is an element having an action of reducing the solid solution N to suppress the dynamic strain aging and an action of enhancing hydrogen embrittlement resistance.

When the Al content is less than 0.005%, the above effect can not be obtained. Accordingly, the Al content in the chemical composition in the disclosure is 0.005% or more, and preferably 0.020% or more.

When the Al content exceeds 0.050%, the effect described above is saturated, and flaws are likely to occur during hot rolling. Therefore, the Al content in the chemical composition in the disclosure is 0.050% or less, and preferably 0.040% or less.
P: From 0 to 0.030%

P is an element that segregates at grain boundaries and degrades hydrogen embrittlement resistance and deteriorates cold workability.

When the P content exceeds 0.030%, deterioration of hydrogen embrittlement resistance and deterioration of cold workability become conspicuous. Accordingly, the P content in the chemical composition in the disclosure is 0.030% or less, and preferably 0.015% or less.

Since the steel wire of the disclosure need not contain P, the lower limit of the P content is 0%. However, from the viewpoint of reducing manufacturing costs (dephosphorization costs), the P content may be more than 0%, 0.002% or more, or 0.005% or more.
S: From 0 to 0.030%

Like P, S is an element that segregates at grain boundaries and deteriorates hydrogen embrittlement resistance and deteriorates cold workability.

When the S content exceeds 0.030%, deterioration of hydrogen embrittlement resistance and deterioration of cold workability become conspicuous. Accordingly, the S content is 0.030% or less, preferably 0.015% or less, and more preferably 0.010% or less.

Since the steel wire of the disclosure need not contain S, the lower limit of the S content is 0%. However, from the viewpoint of reducing manufacturing costs (desulfurization costs), the S content may be more than 0%, 0.002% or more, or 0.005% or more.
N: From 0 to 0.0050%

N is an element that deteriorates cold workability due to dynamic strain aging and sometimes deteriorates hydrogen embrittlement resistance. In order to avoid such an adverse effect, in the chemical composition in the disclosure, the N content is 0.0050% or less. The N content is preferably 0.0040% or less. The lower limit of the N content is 0%. However, from the viewpoint of reducing manufacturing costs (denitrification costs), the N content may be more than 0%, 0.0010% or more, 0.0020% or more, or 0.0030% or more.
Cr: From 0 to 1.00%

Cr is an optional element. In other words, the lower limit of the Cr content in the chemical composition in the disclosure is 0%.

Cr is an element which increases the tensile strength of steel. From the viewpoint of obtaining such an effect, the Cr content is preferably more than 0%, more preferably 0.01% or more, still more preferably 0.03% or more, still more preferably 0.05% or more, and particularly preferably 0.10% or more.

On the other hand, when the Cr content is more than 1.00%, martensite tends to be formed, thereby deteriorating cold workability. Accordingly, the Cr content in the chemical composition in the disclosure is 1.00% or less, preferably 0.70% or less, and more preferably 0.50% or less.
Ti: From 0 to 0.050%

Ti is an optional element. In other words, the lower limit of the Ti content in the chemical composition in the disclosure is 0%.

Ti is a deoxidizing element and is an element having an action of forming TiN, reducing solid solution N to suppress dynamic strain aging, and enhancing hydrogen embrittlement resistance. From the viewpoint of obtaining such effects, the Ti content is preferably more than 0%, more preferably 0.005% or more, and still more preferably 0.015% or more.

On the other hand, when the Ti content exceeds 0.050%, the effects described above are saturated, and flaws are likely to occur during hot rolling. Accordingly, the Ti content in the chemical composition in the disclosure is 0.050% or less, and preferably 0.035% or less.
Nb: From 0 to 0.05%

Nb is an optional element. In other words, the lower limit of the Nb content in the chemical composition in the disclosure is 0%.

Nb is an element having an action of forming NbN and reducing solid solution N to suppress dynamic strain aging, and an action of enhancing hydrogen embrittlement resistance. From the viewpoint of obtaining such effects, the Nb content is preferably more than 0%, more preferably 0.005% or more, and still more preferably 0.015% or more.

On the other hand, when the Nb content exceeds 0.05%, the effects described above are saturated, and flaws are likely to occur during hot rolling. Accordingly, the Nb content in the chemical composition in the disclosure is 0.05% or less, and preferably 0.035% or less.
V: From 0 to 0.10%

V is an optional element. In other words, the lower limit of the V content in the chemical composition in the disclosure is 0%.

V is an element having an action of forming VN and reducing solid solution N to suppress dynamic strain aging, and an action of enhancing hydrogen embrittlement resistance. From the viewpoint of obtaining such effects, the V content is preferably more than 0%, and more preferably 0.02% or more.

On the other hand, when the V content exceeds 0.10%, the effects described above are saturated, and flaws are likely to occur during hot rolling. Accordingly, the V content in the chemical composition in the disclosure is 0.10% or less, and preferably 0.05% or less.
B: From 0 to 0.0050%

B is an optional element. In other words, the lower limit of the B content in the chemical composition in the disclosure is 0%.

B suppresses grain boundary ferrite and has an effect of improving cold workability and hydrogen embrittlement resistance and an effect of promoting bainite transformation. From the viewpoint of obtaining such effects, the B content is preferably more than 0%, and more preferably 0.0003% or more.

On the other hand, when the B content exceeds 0.0050%, the above effects are saturated. Accordingly, the B content in the chemical composition in the disclosure is 0.0050% or less.

From the viewpoint of obtaining the effects of each of the above-described optional elements, the chemical composition in the disclosure may contain, based on % by mass, one, or two or more of Cr: more than 0 and 1.00% or less, Ti: more than 0 and 0.050% or less, Nb: more than 0 and 0.05% or less, V: more than 0 and 0.10% or less, and B: more than 0 and 0.0050% or less.
O: From 0 to 0.0030%

O exists in the steel wire as an oxide such as Al and Ti. When the O content exceeds 0.0030%, a coarse oxide is formed in the steel and fatigue failure tends to occur. Accordingly, the O content in the chemical composition in the disclosure is 0.0030% or less, and preferably 0.0020% or less.

Since the steel wire of the disclosure need not contain O, the lower limit of the O content is 0%. However, from the viewpoint of reducing manufacturing costs (deoxidation costs), the O content may be more than 0%, 0.0002% or more, or 0.0005% or more.
Balance: Fe and impurities

In the chemical composition in the disclosure, the balance excluding the above-described elements is Fe and impurities.

Herein, an impurity means a component contained in a raw material or a component mixed in a manufacturing process and not intentionally contained in steel.

Examples of impurities include any elements other than the above-described elements. An element as an impurity may be contained singly or two or more kinds thereof may be contained.

<Microstructure >

Next, the microstructure of the steel wire of the disclosure will be described.

(Area Ratio of Bainite)

The microstructure of the steel wire of the the disclosure is composed of bainite having an area ratio of (35×[C.%]+50)% or more where the % by mass of C is defined as [C %] and the balance which is at least one of proeutectoid ferrite or pearlite.

As a result, the cold workability and hydrogen embrittlement resistance are improved.

When the area ratio of bainite in the microstructure of a steel wire is less than (35×[C %]+50)%, the strength (tensile strength, hardness, etc.) of the steel wire becomes nonuniform, and therefore, cracks are likely to occur at the time of cold working on a non-heat treated machine part (in other words, the cold workability deteriorates).

When the area ratio of bainite in the microstructure of a steel wire is less than (35×[C %]+50)%, also in a non-heat treated machine part obtained by cold working this steel wire, the area ratio of the bainite in the microstructure is less than (35×[C %]+50)%. As a result, hydrogen embrittlement resistance of the non-heat treated machine part deteriorates.

From the viewpoint of further improving cold workability and hydrogen embrittlement resistance, the area ratio of bainite is preferably (35×[C %]+55)% or more, and more preferably (35×[C %]+60)% or more.

From the viewpoint of manufacturability, the area ratio of bainite is preferably 98% or less, more preferably 95% or less, and still more preferably 90% or less.

In the microstructure of the steel wire of the present disclosure, a specific preferred range of the area ratio of bainite depends on [C %], and is preferably from 60 to 98%, more preferably from 65 to 95%, and particularly preferably from 70 to 90%.

The balance of the microstructure of the steel wire of the disclosure is at least one of proeutectoid ferrite or pearlite.

When the balance contains martensite, cold workability and hydrogen embrittlement resistance when formed as a non-heat treated machine part deteriorate.

In the present specification, the area ratio (%) of bainite refers to a value obtained by the following procedure.

First, the C cross section of a steel wire is etched using nital, and the microstructure is exposed.

Next, four observation positions are selected at intervals of 90° in the circumferential direction from a position of 50 μm depth in the C cross section after etching (or a circumferential position), and for each observation position, FE-SEM (Field Emission—Scanning Electron Microscope) is used to take an SEM photograph of magnification 1,000 times.

Likewise, four observation positions are selected at intervals of 90° in the circumferential direction from the depth of 0.25D in the C cross section after etching (or a circumferential position), and for each observation position, an SEM photograph of magnification 1,000 times is taken using FE-SEM.

In the obtained eight SEM pictures, structures other than bainite (proeutectoid ferrite, pearlite, or the like) are visually marked and the area ratio (%) of the structure other than bainite to the entire microstructure is obtained by image analysis. The area ratio (%) of bainite is obtained by subtracting the obtained area ratio (%) of the structure other than bainite from 100%.

(AR)

The AR of the steel wire of the disclosure (or the average aspect ratio of a bainite grain measured at a depth of 50 μm in the L cross section) is 1.4 or more. This improves hydrogen embrittlement resistance. The reason for this is considered to be that, as described above, the elongated bainite grain (or a bainite grain having an AR of 1.4 or more) in the surface layer is resistant to hydrogen intrusion from the surface of a steel wire and/or is resistant to crack propagation.

When the AR of a steel wire is less than 1.4, the AR of the non-heat treated machine part obtained by cold working the steel wire also becomes less than 1.4. In this case, since it is difficult to obtain the above-described effect (an effect of resisting hydrogen intrusion and/or an effect of resisting crack propagation), hydrogen embrittlement resistance of the non-heat treated machine part is not improved.

From the viewpoint of further improving hydrogen embrittlement resistance, the AR is preferably 1.5 or more, and more preferably 1.6 or more.

From the viewpoint of manufacturability of a steel wire, the AR is preferably 2.5 or less, and more preferably 2.0 or less.

In the present specification, a bainite grain means bainite in a region surrounded by a boundary where the orientation difference is 15° or more in the crystal orientation map of the bcc structure obtained by EBSD (electron back scattering diffraction) method. In other words, a boundary at which the orientation difference is 15° or more is the grain boundary of a bainite grain.

In the present specification, the AR means a value measured by the following procedure.

First, four observation positions are selected every 2.0 mm on the straight line indicating the position of the depth of 50 μm in the L cross section of a steel wire, a crystal orientation map of the bcc structure in a region of 50 μm in the depth direction and 250 μm in the axial direction with each observation position as the center is acquired using the EBSD apparatus.

From a group of bainite grains traversed by a straight line indicating a position of a depth of 50 μm in the entirety of the obtained four crystal orientation maps, ten bainite grains are selected in descending order of circle equivalent diameter.

Next, the aspect ratio of each of the 10 selected bainite grains is determined and the average value of the aspect ratios of ten bainite grains (or 10 values) is defined as AR (or the average aspect ratio of bainite grains measured at a depth of 50 μm in the L cross section).

In the present specification, the aspect ratio of a bainite grain means a value obtained by dividing the major axis of the bainite grain by the minor axis (or major axis/minor axis). Here, the major axis of a bainite grain means the maximum length of the bainite grain, and the minor axis of a bainite grain means the maximum value of the length in the direction orthogonal to the major axis direction.

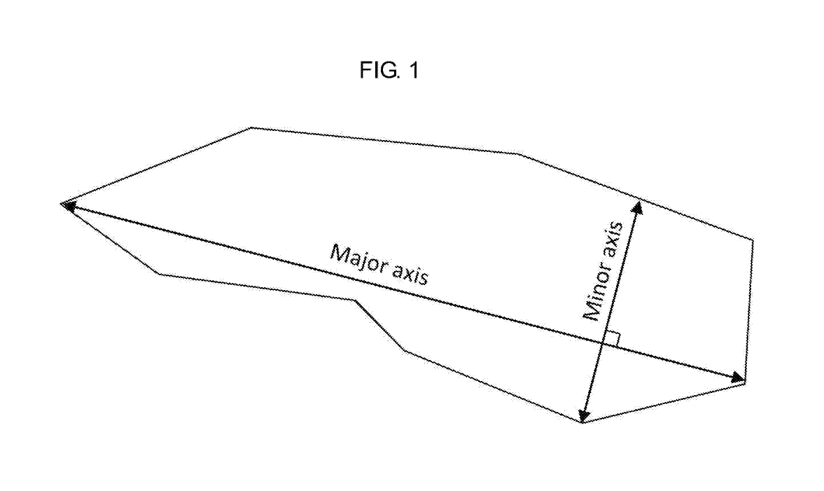

FIG. 1 is a conceptual diagram showing an example of a bainite grain in the L cross section of a steel wire according to an example of the disclosure.

In FIG. 1, not only the grain boundary of a bainite grain but also the major axis and the minor axis of the bainite grain are illustrated.

The shape of a bainite grain may be a polygonal shape as shown in FIG. 1, an elliptical shape, or a shape other than a polygonal shape and an elliptical shape (for example, an indefinite shape).

In short, a bainite grain may have an AR of 1.4 or more, and its shape is not particularly limited.

(Ratio of Aspect Ratios [Surface Layer/0.25D])

The ratio of the aspect ratios [surface layer/0.25D] (or (AR)/(the average aspect ratio of a bainite grain measured at the depth of 0.25D in L cross section)) of the steel wire of the disclosure is 1.1 or more.

When the ratio of the aspect ratios [surface layer/0.25D] of the steel wire of the disclosure is 1.1 or more, as described above, hydrogen embrittlement resistance is improved. The reason for this is considered to be that an elongated bainite grain in the surface layer becomes resistant to hydrogen ingress from the surface of the steel wire and/or resistant to crack propagation.

Since the ratio of the aspect ratios [surface layer/0.25D] of the steel wire of the disclosure is 1.1 or more, the strain concentrates on the surface layer of the steel wire, and therefore, it is possible to efficiently improve hydrogen embrittlement resistance.

When the ratio of the aspect ratios [surface layer/0.25D] is less than 1.1, not only the surface layer of a steel wire but also the strain inside the steel wire need to be increased, and therefore, there are cases where hydrogen embrittlement resistance can not be efficiently improved or the productivity of the steel wire is lowered.

The ratio of the aspect ratios [surface layer/0.25D] is preferably 1.2 or more from the viewpoint of improving hydrogen embrittlement resistance.

The ratio of the aspect ratios [surface layer/0.25D] is, from the viewpoint of manufacturability of the steel wire, preferably 2.0 or less, more preferably 1.8 or less, and particularly preferably 1.6 or less.

In the present specification, the average aspect ratio of a bainite grain measured at the depth of 0.25D in the L cross section is measured in a similar method to the AR measurement method described above, except that the observation position is changed from the 50 μm depth position in the L cross section to the 0.25D depth position in the L cross section.

(GD)

The GD of the steel wire of the disclosure (or the average grain size of a bainite grain measured at the depth of 50 μm in the C cross section) is (15/AR) μm or less. As described above, cold workability and hydrogen embrittlement resistance are improved by fineness of a bainite grain (specifically, GD is (15/AR) μm or less).

From the viewpoint of further improving cold workability and hydrogen embrittlement resistance, GD is preferably 10.0 μm or less, and more preferably 9.5 μm or less.

GD is, from the viewpoint of manufacturability of the steel wire, preferably 5.0 μm or more, and more preferably 6.0 μm or more.

In the present specification, the GD means a value measured by the following procedure.

First, eight observation positions are selected every 45° in the circumferential direction on the circumference indicating the position of the depth of 50 μm in the C cross section of a steel wire, a crystal orientation map of the bcc structure in a region of 50 μm×50 μm with each observation position as the center is acquired using the EB SD apparatus.

The circle equivalent diameters of all the bainite grains contained in the whole of the obtained eight crystal orientation maps are measured. The average value of the obtained measurement values is defined as GD (or the average grain size of a bainite grain measured at a depth of 50 μm in the C cross section).

(Grain Size Ratio [Surface Layer/0.25D])

The ratio [surface layer/0.25D] (or (GD)/(the average grain size of a bainite grain measured at a depth of 0.25D in the C cross section)) of the grain size of the steel wire of the disclosure is less than 1.0.

When the ratio [GD/0.25D] of a grain size of the steel wire of the disclosure is less than 1.0, cold workability and hydrogen embrittlement resistance are improved.

From the viewpoint of further improving cold workability and hydrogen embrittlement resistance, the ratio [GD/0.25D] of the grain size is preferably 0.98 or less, more preferably 0.95 or less , and particularly preferably 0.93 or less.

The ratio [GD/0.25D] of the grain size is, from the viewpoint of manufacturability of the steel wire, preferably 0.80 or more, more preferably 0.90 or more, and particularly preferably 0.91 or more.

In the present specification, the average grain size of a bainite grain measured at the depth of 0.25D in the C cross section is measured in a similar method to the GD measurement method described above, except that the observation position is changed from the 50 μm depth position in the C cross section to the 0.25D depth position in the C cross section.

The steel wire of the disclosure has a tensile strength (TS) of from 900 to 1,500 MPa.

Since the steel wire of the disclosure has a TS of 900 MPa or more, by subjecting the steel wire to cold working, it is easy to manufacture a non-heat treated machine part having a TS of 1,100 MPa or more.

In a conventional steel wire, when the TS of the steel wire is 900 MPa or more, the cold workability tends to decrease.

However, when the steel wire of the disclosure has the above-described chemical composition and microstructure, the steel wire has excellent cold workability while TS is 900 MPa or more.

When the steel wire of the disclosure has a TS of 1,500 MPa or less, the manufacturability and cold workability of steel wire are excellent.

In the present specification, the tensile strength (TS) of a steel wire and the tensile strength (TS) of a non-heat treated machine part are values measured in accordance with a test method described in JIS Z 2201 (2011), using a 9A test piece of JIS Z 2201 (2011).

The TS of the steel wire of the disclosure is, from the viewpoint of further improving the manufacturability and cold workability of the steel wire, preferably from 900 to 1,300 MPa, and more preferably from 900 to 1,200 MPa.

The D (or the diameter of a steel wire) of a steel wire of the disclosure is preferably from 3 to 30 mm, more preferably from 5 to 25 mm, and particularly preferably from 5 to 20 mm.

From the viewpoint of cold workability, the steel wire of the disclosure preferably has a critical compression ratio of 75% or more. The method of measuring the critical compression ratio is as shown in Examples described below.

Examples of a method of manufacturing the steel wire of the disclosure include the following manufacturing method A.

The manufacturing method A includes:

a process of obtaining a wire rod by subjecting a billet having the chemical composition in the disclosure to a temperature of from 1,000 to 1,150° C., and performing a hot rolling at a finish rolling temperature of from 800 to 950° C.;

a process of isothermal transformation treatment by immersing the above-described wire rod having a temperature of from 800 to 950° C. in a molten salt bath at from 400 to 550° C. for 50 seconds or longer;

a process of water-cooling the wire rod subjected to isothermal transformation treatment to a temperature of from 300° C. or lower; and

a process of obtaining a steel wire by subjecting the water-cooled wire rod to wire drawing in which the total area reduction is from 15 to 35%.

The chemical composition of a steel wire (target material) obtained by the manufacturing method A can be regarded as being the same as the chemical composition of a billet (raw material) in the manufacturing method A. The reason for this is that neither of the hot rolling, the isothermal transformation treatment, the water cooling, and the wire drawing does not affect the chemical composition of the steel.

Since the manufacturing method A includes the process of isothermal transformation treatment and the process of water cooling, it is easy to manufacture the steel wire of the disclosure in which the area ratio of bainite and the balance satisfy the above-described conditions.

For example, in the process of isothermal transformation treatment, since the dipping time for immersing the wire rod in the molten salt bath is 50 seconds or more, the area ratio of bainite and the balance tend to satisfy the above-described conditions, respectively.

The upper limit of the immersion time is not particularly limited. From the viewpoint of the productivity of a steel wire, the immersion time is preferably 100 seconds or less, and more preferably 80 seconds or less.

In the process (or a process including wire drawing; hereinafter, also referred to as “wire drawing process”) of obtaining the above-described steel wire, since the total area reduction ratio is 15% or more, it is easy to manufacture a steel wire having a tensile strength of 900 MPa or more.

In the wire drawing process, since the total area reduction is 35% or less, a steel wire having an AR of 1.4 or more and a ratio of aspect ratios [surface layer/0.25D] of 1.1 or more (or a steel wire in which bainite grains of a steel surface layer are elongated compared to bainite grains inside the steel) is easy to manufacture.

The wire drawing process may be a process including only one wire drawing or may include a process including a plurality of wire drawings.

Specifically, the total area reduction in the wire drawing process of from 15 to 35% may be achieved by one wire drawing or a plurality of wire drawings.

When the wire drawing process includes only one wire drawing, it is preferable to use a die whose approach half angle exceeds 10° as a die used for wire drawing. As a result, it is easy to manufacture a steel wire having a ratio of aspect ratios [surface layer/0.25D] of 1.1 or more.

When the wire drawing process includes a plurality of wire drawings, it is preferable to carry out a plurality of wire drawings under the condition that the area reduction rate in the final pass is 10% or less. As a result, it is easy to manufacture a steel wire having a ratio of aspect ratios [surface layer/0.25D] of 1.1 or more.

When the wire drawing process includes a plurality of wire drawings, the area reduction rate in the final pass is more preferably from 5 to 10%, more preferably from 5 to 9%, and particularly preferably from 5 to 8%.

The steel wire of the present disclosure is particularly suitable as a steel wire for producing a non-heat treated machine part including a cylindrical shaft having a tensile strength of 1,100 to 1,500 MPa.

In other words, by cold working the steel wire of the disclosure (and preferably keeping the steel wire at from 100 to 400° C. after cold working), it is easy to manufacture a non-heat treated machine part including a cylindrical shaft having a tensile strength of from 1,100 to 1,500 MPa.

Here, the chemical composition of a non-heat treated machine part obtained by cold working the steel wire of the disclosure (and preferably holding the steel wire at from 100 to 400° C. after cold working) can be regarded as being the same as the chemical composition of the steel wire of the disclosure. The reason is that cold working and heat treatment do not affect the chemical composition of steel.

The microstructure of a non-heat treated machine part obtained by cold working the steel wire of the disclosure (and, if necessary, performing a heat treatment at from 100 to 400° C. after cold working) can be regarded as the same as the microstructure of the steel wire of the disclosure. The reason for this is that the amount of cold working for obtaining a non-heat treated machine part having a cylindrical shaft is very small.

[Non-Heat Treated Machine Part]

Hereinafter, a first embodiment and a second embodiment of the non-heat treated machine part (hereinafter, also simply referred to as “machine part”) of the disclosure will be described.

The machine part of the first embodiment of the disclosure includes a cylindrical shaft, wherein

the chemical composition thereof is the chemical composition in the disclosure as described above,

the microstructure is composed of bainite having an area ratio of (35×[C %]+50)% or more where the % by mass of C is defined as [C %] and the balance which is at least one of proeutectoid ferrite or pearlite,

in a case in which a cross section parallel to the axial direction of the cylindrical shaft and including the central axis is defined as an L cross section, a cross section perpendicular to the axial direction of the cylindrical shaft is defined as a C cross section, the diameter of the cylindrical shaft is defined as D, the average aspect ratio of a bainite grain measured at a depth of 50 μm from the cylindrical shaft surface in the L cross section is defined as AR, and the average grain size of a bainite grain measured at a depth of 50 μm from the cylindrical shaft surface in the C cross section is defined as GD, AR is 1.4 or more, (AR)/(the average aspect ratio of a bainite grain measured at a depth of 0.25D from the cylindrical shaft surface in the L cross section) is 1.1 or more, GD is (15/AR) μm or less, and (GD/the average grain size of a bainite grain measured at a depth of 0.25D from the cylindrical shaft surface in the C cross section) is less than 1.0, and

the tensile strength (TS) of the cylindrical shaft is from 1,100 to 1,500 MPa.

The chemical composition and the microstructure of the cylindrical shaft portion (or bainite area ratio, AR, ratio of aspect ratios [surface layer/0.25D], GD, and ratio of average grain sizes [surface layer/0.25D], the same hereinafter) in the machine part of the first embodiment are respectively similar to the chemical composition and microstructure of the steel wire of the disclosure.

Accordingly, the machine part of the first embodiment is excellent in hydrogen embrittlement resistance.

The machine part of the first embodiment can be manufactured by a steel wire having excellent cold workability (for example, a steel wire of the disclosure).

In the machine part of the first embodiment, the chemical composition and the microstructure of the cylindrical shaft of a preferred embodiment are the same as the chemical composition and the microstructure of a preferred embodiment in the steel wire of the disclosure, respectively.

The machine part of the second embodiment of the disclosure is a cold-worked product of the steel wire of the disclosure (or a machine part obtained by cold working the steel wire of the disclosure), and the tensile strength of the cylindrical shaft is from 1,100 to 1,500 MPa.

Accordingly, the machine part of the second embodiment is excellent in hydrogen embrittlement resistance.

In the machine part of the second embodiment, the chemical composition and the microstructure of the cylindrical shaft of a preferred embodiment are the same as the chemical composition and the microstructure of a preferred embodiment in the steel wire of the disclosure, respectively.

In the machine part of the disclosure, the first embodiment and the second embodiment may have an overlapping portion.

In other words, not only a machine part corresponding to either one of the first embodiment and the second embodiment but also a machine part corresponding to both of the first embodiment and the second embodiment is naturally included in the scope of the machine part of the disclosure.

From the viewpoint of further improving the manufacturability and hydrogen embrittlement resistance of a machine part, the TS of the machine part of the disclosure (a machine part of the first embodiment and/or the second embodiment) is preferably from 1,100 MPa and less than 1,410 MPa, more preferably from 1,100 to 1,406 MPa, and particularly preferably from 1,100 to 1,400 MPa.

The machine part of the disclosure is not particularly limited as long as the part is a non-heat treated machine part including a cylindrical shaft, and among them, non-heat treated bolt is particularly preferable.

Examples of a method of manufacturing a machine part of the disclosure include the following manufacturing method X.

The manufacturing method X includes a process of cold working the steel wire of the disclosure to obtain a machine part.

The manufacturing method X preferably includes a process (hereinafter, also referred to as “holding process”) of holding a machine part obtained by cold working within a temperature range of from 100 to 400° C.

By including the holding process, it is easier to manufacture a machine part having a tensile strength of from 1,100 to 1,500 MPa.

The holding temperature in the holding process is from 100 to 400° C., preferably from 200 to 400° C., and more preferably from 300 to 400° C.

The holding time in the holding process (or the time for holding a machine part within the above temperature range) is preferably from 10 to 120 minutes, and more preferably from 10 to 60 minutes.

The steel wire for non-heat treated machine parts and non-heat treated machine part of the disclosure as described above can be used for a variety of machines such as automobiles, and constructions.

### EXAMPLES

Hereinafter, Examples of the disclosure will be described, but the disclosure is not limited to the following Examples.

[Conditions 1 to 28]

### <Manufacture of Steel Wire>

Steel wires having the diameters (D) shown in Table 3 were manufactured using a billet having the chemical composition shown in Table 1.

In the chemical composition of each steel in Table 1, the balance other than the elements shown in Table 1 is Fe and impurities.

For conditions 1 to 4, 6 to 9, 11, 12, and 14 to 26, a billet was subjected to hot rolling, isothermal transformation treatment, water cooling, and wire drawing sequentially under conditions shown in Table 2 to obtain a steel wire having the diameter (D) as shown in Table 3.

For conditions 5, 27, and 28, a billet was subjected to hot rolling under conditions shown in Table 2, then, air cooling, reheating at a heating temperature of 950° C., lead patenting at a lead bath temperature of 580° C., and cooling sequentially, and subsequently, wire drawing under conditions shown in Table 2 to obtain a steel wire having the diameter (D) as shown in Table 3.

For conditions 10 and 13, a billet was subjected to hot rolling under conditions shown in Table 2, subsequently air cooling, and subsequently, wire drawing under conditions shown in Table 2 to obtain a steel wire having the diameter (D) as shown in Table 3.

<Measurement on Steel Wire>

For each condition of steel wire, by the above-described methods,

measurement of area ratio of bainite,

confirmation of the balance,

measurement of AR (or the average aspect ratio of a bainite grain at the depth of 50 μm in the L cross section),

measurement of ratio of the aspect ratios [surface layer/0.25D] (or (AR)/(the average aspect ratio of a bainite grain measured at the depth of 0.25D in the L cross section)),

measurement of GD (or the average grain size of a bainite grain at the depth of 50 μm in the C cross section),

measurement of the grain size ratio [surface layer/0.25D] (or (GD)/(the average grain size of a bainite grain measured at the depth of 0.25D in the C cross section)), and

measurement of tensile strength (TS) were performed, respectively. Results of each measurement are shown in Table 3.

<Cold Workability of Steel Wire (Measurement of Critical Compression Ratio)>

For each condition of steel wire, cold workability was evaluated by measuring the following critical compression ratio.

First, a steel wire was machined to produce a sample having a diameter of D (or the diameter of a steel wire) and a length of 1.5×D.

Both end faces of the obtained sample were constrained using a pair of molds. For each of the pair of molds, a mold having concentric grooves on the contact surface with an end face of the sample was used. In this state, the sample was compressed in the longitudinal direction. By performing a test in which the compression ratio of the sample in this compression was variously changed, the maximum compression ratio at which cracking of the sample did not occur was obtained.

The maximum compression ratio at which cracking of a sample did not occur was defined as the critical compression ratio (%).

As a result, when the critical compression ratio was 75% or more, it is determined that the cold workability was good (G), and when the critical compression ratio was less than 75%, it was determined that the cold workability was no good (NG).

The above results are shown in Table 3.

<Manufacture of Machine Part>

A steel wire of each condition was subjected to cold working (cold forging), and processed into a flanged bolt shape. The processed steel wire was heated to 350° C. and held at this temperature for 30 minutes to obtain a non-heat treated bolt as a machine part.

<Measurement of Tensile Strength (TS) of Machine Part>

The TS of a shaft of the obtained machine part (non-heat treated bolt) was measured by the above-described measurement method.

The results are shown in Table 3.

<Evaluation of Hydrogen Embrittlement Resistance of Machine Part>

For each of the obtained machine parts (non-heat treated bolts), hydrogen embrittlement resistance was measured by the following method.

First, 0.5 ppm of diffusible hydrogen was contained in a machine part by charging the machine part with electric field hydrogen.

Next, Cd plating was applied to a sample in order to prevent hydrogen from releasing into the atmosphere from the machine part during a test.

Next, in the atmosphere, a load of 90% of the maximum tensile load of the machine part was applied to the machine part, and in this state, the machine part was held for 100 hours or more.

As a result, when breakage did not occur at the lapse of 100 h, it was determined that hydrogen embrittlement resistance was good (G), and when breakage occurred at the lapse of 100 h, it was determined that hydrogen embrittlement resistance was no good (NG).

The above results are shown in Table 3.

TABLE 1

| Steel | C | Si | Mn | Al | P | S | N | Cr | Ti | Nb | V | B | O |
|---|---|---|---|---|---|---|---|---|---|---|---|---|---|
| A | 0.26 | 0.18 | 0.91 | 0.036 | 0.015 | 0.011 | 0.0032 | 0.14 | 0.021 | — | — | 0.0018 | 0.0014 |
| B | 0.26 | 0.19 | 1.22 | 0.032 | 0.016 | 0.009 | 0.0036 | — | 0.022 | — | — | 0.0022 | 0.0015 |
| C | 0.28 | 0.19 | 0.95 | 0.035 | 0.009 | 0.008 | 0.0035 | 0.16 | 0.018 | 0.02 | — | 0.0017 | 0.0012 |
| D | 0.28 | 0.19 | 1.08 | 0.033 | 0.014 | 0.009 | 0.0034 | 0.15 | 0.019 | — | — | 0.0021 | 0.0014 |
| E | 0.30 | 0.21 | 0.98 | 0.032 | 0.009 | 0.008 | 0.0039 | 0.16 | 0.021 | — | 0.07 | 0.0019 | 0.0011 |
| F | 0.37 | 0.19 | 1.07 | 0.037 | 0.012 | 0.008 | 0.0032 | 0.17 | 0.017 | — | — | 0.0017 | 0.0015 |
| G | 0.39 | 0.23 | 1.42 | 0.036 | 0.008 | 0.009 | 0.0034 | 0.22 | — | — | — | — | 0.0017 |
| H | 0.38 | 0.22 | 1.40 | 0.039 | 0.007 | 0.008 | 0.0036 | — | — | — | — | — | 0.0011 |
| I | 0.25 | 0.06 | 1.62 | 0.029 | 0.013 | 0.010 | 0.0044 | — | 0.011 | | — | — | 0.0013 |
| J | 0.22 | 0.46 | 0.97 | 0.041 | 0.009 | 0.009 | 0.0038 | 0.35 | — | | — | 0.0016 | 0.0012 |
| K | 0.32 | 0.11 | 0.55 | 0.033 | 0.008 | 0.008 | 0.0037 | 0.52 | — | 0.01 | — | 0.0014 | 0.0009 |
| L | 0.29 | 0.17 | 1.94 | 0.035 | 0.011 | 0.009 | 0.0041 | — | — | — | 0.06 | — | 0.0015 |

TABLE 2

| | | Manufacturing Conditions of Steel Wire | | | | | | | |
|---|---|---|---|---|---|---|---|---|---|
| | | Hot rolling | | Isothermal transformation treatment | | Water cooling | Wire drawing | | |
| | | | Finish | Molten | Molten | Water | Total | Final pass | Approach |
| | | Heating | rolling | salt bath | salt bath | cooling end | area | area | half angle |
| | | temperature | temperature | temperature | immersion | temperature | reduction | reduction | of dice |
| Condition | Steel | (° C.) | (° C.) | (° C.) | time (s) | (° C.) | (%) | (%) | (°) |
| 1 | A | 1090 | 860 | 450 | 65 | 220 | 30.6 | 7.5 | 5 |
| 2 | A | 1080 | 860 | 450 | 65 | 220 | 30.6 | 30.6 | 5 |
| 3 | B | 1080 | 860 | 450 | 65 | 220 | 30.6 | 7.5 | 5 |
| 4 | B | 1080 | 860 | 450 | 65 | 220 | 30.6 | 30.6 | 12 |
| 5 | B | 1080 | 860 | (Air cooling → reheating → lead | | | 30.6 | 30.6 | 12 |
| | | | | patenting → cooling) | | | | | |
| 6 | C | 1090 | 860 | 450 | 65 | 220 | 30.6 | 7.5 | 5 |
| 7 | D | 1090 | 860 | 450 | 65 | 220 | 30.6 | 30.6 | 12 |
| 8 | D | 1090 | 860 | 450 | 65 | 220 | 30.6 | 30.6 | 5 |
| 9 | E | 1090 | 860 | 450 | 65 | 220 | 30.6 | 7.5 | 5 |
| 10 | E | 1090 | 860 | — | — | (Air | 30.6 | 7.5 | 5 |
| | | | | | | cooling) | | | |
| 11 | F | 1090 | 860 | 450 | 65 | 220 | 30.6 | 30.6 | 12 |
| 12 | F | 1090 | 860 | 450 | 65 | 220 | 30.6 | 7.5 | 12 |
| 13 | F | 1090 | 860 | — | — | (Air | 30.6 | 7.5 | 12 |
| | | | | | | cooling) | | | |
| 14 | G | 1090 | 860 | 450 | 65 | 220 | 30.6 | 7.5 | 5 |
| 15 | G | 1090 | 860 | 450 | 65 | 220 | 30.6 | 30.6 | 5 |
| 16 | H | 1060 | 870 | 460 | 65 | 220 | 20.3 | 20.3 | 12 |
| 17 | I | 1100 | 870 | 450 | 65 | 220 | 33.3 | 7.5 | 5 |
| 18 | J | 1070 | 880 | 470 | 70 | 200 | 30.6 | 30.6 | 12 |
| 19 | K | 1070 | 880 | 470 | 70 | 200 | 30.6 | 30.6 | 12 |
| 20 | L | 1070 | 880 | 470 | 70 | 200 | 30.6 | 7.5 | 5 |
| 21 | D | 1080 | 870 | 420 | 12 | 220 | 30.6 | 30.6 | 12 |
| 22 | F | 1080 | 870 | 420 | 12 | 220 | 30.6 | 30.6 | 12 |
| 23 | K | 1100 | 870 | 470 | 70 | 200 | 49.4 | 18 | 5 |
| 24 | L | 1080 | 870 | 470 | 70 | 200 | 30.6 | 11.7 | 5 |
| 25 | H | 1060 | 870 | 460 | 65 | 220 | 0 | — | — |
| 26 | J | 1060 | 870 | 470 | 70 | 200 | 10.3 | 10.3 | 5 |

| | | | | | | | |
|---|---|---|---|---|---|---|---|
| 27 | L | 1080 | 860 | (Air cooling → reheating → lead | 30.6 | 7.5 | 5 |
| | | | | patenting → cooling) | | | |
| 28 | F | 1080 | 860 | (Air cooling → reheating → lead | 49.4 | 18 | 5 |
| | | | | patenting → cooling) | | | |

TABLE 3

| | | | | | | Bainite grain | | | | | | | | | | |
|---|---|---|---|---|---|---|---|---|---|---|---|---|---|---|---|---|
| | | | | | | | Ratio of | | | Grain | | | | | | |
| | | | Microstructure | | | | aspect | | | size | Results of steel wire | | | Results of | | |
| | | | | Area | | | ratios | | | ratios | | Cold workability | | machine part | | |
| | | | 35 × | ratio of | | | [Surface | | | [Surface | | Critical | | | Hydrogen | |
| Con- | | D | [C %] + | bainite | Balance | | layer/ | 15/ | GD | layer/ | TS | compression | Eval- | TS | embrittlement | |
| dition | Steel | (mm) | 50 (%) | (%) | structure | AR | 0.25 D] | AR | (μm) | 0.25 D] | (MPa) | ratio | uation | (MPa) | resistance | Note |
| 1 | A | 15.0 | 59 | 72 | F, P | 1.7 | 1.3 | 8.8 | 8.1 | 0.92 | 905 | 80%≤ | G | 1134 | G | Example |
| 2 | A | 15.0 | 59 | 72 | F, P | 1.2 | 0.9 | 12.5 | 11.7 | 0.91 | 908 | 80%≤ | G | 1138 | NG | Compar- |
| | | | | | | | | | | | | | | | | ative |
| | | | | | | | | | | | | | | | | Example |
| 3 | B | 15.0 | 59 | 81 | F, P | 1.6 | 1.3 | 9.4 | 8.6 | 0.93 | 952 | 80%≤ | G | 1161 | G | Example |
| 4 | B | 15.0 | 59 | 81 | F, P | 1.7 | 1.3 | 8.8 | 8.1 | 0.92 | 957 | 80%≤ | G | 1166 | G | Example |
| 5 | B | 15.0 | 59 | 94 | P | 1.5 | 1.1 | 10.0 | 13.3 | 1.14 | 962 | 74% | NG | 1171 | G | Compar- |
| | | | | | | | | | | | | | | | | ative |
| | | | | | | | | | | | | | | | | Example |
| 6 | C | 15.0 | 60 | 82 | F, P | 1.7 | 1.4 | 8.8 | 7.9 | 0.93 | 937 | 80%≤ | G | 1136 | G | Example |
| 7 | D | 15.0 | 60 | 81 | F, P | 1.6 | 1.2 | 9.4 | 8.2 | 0.93 | 962 | 80%≤ | G | 1161 | G | Example |
| 8 | D | 15.0 | 60 | 81 | F, P | 1.3 | 1.1 | 11.5 | 10.4 | 0.92 | 966 | 79% | G | 1165 | NG | Compar- |
| | | | | | | | | | | | | | | | | ative |
| | | | | | | | | | | | | | | | | Example |
| 9 | E | 15.0 | 61 | 83 | F, P | 1.8 | 1.4 | 8.3 | 7.4 | 0.91 | 1067 | 79% | G | 1266 | G | Example |
| 10 | E | 15.0 | 61 | 17 | F, P | 1.6 | 1.2 | 9.4 | 8.1 | 0.92 | 949 | 73% | NG | 1148 | NG | Compar- |
| | | | | | | | | | | | | | | | | ative |
| | | | | | | | | | | | | | | | | Example |
| 11 | F | 15.0 | 63 | 89 | F, P | 1.6 | 1.3 | 9.4 | 7.9 | 0.93 | 1048 | 77% | G | 1247 | G | Example |
| 12 | F | 15.0 | 63 | 89 | F, P | 1.9 | 1.6 | 7.9 | 6.8 | 0.91 | 1044 | 78% | G | 1243 | G | Example |
| 13 | F | 15.0 | 63 | 12 | F, P | 1.8 | 1.5 | 8.3 | 7.4 | 0.92 | 931 | 72% | NG | 1130 | NG | Compar- |
| | | | | | | | | | | | | | | | | ative |
| | | | | | | | | | | | | | | | | Example |
| 14 | G | 15.0 | 64 | 75 | F, P | 1.6 | 1.2 | 9.4 | 9.1 | 0.93 | 1151 | 78% | G | 1350 | G | Example |
| 15 | G | 15.0 | 64 | 75 | F, P | 1.2 | 1.0 | 12.5 | 11.6 | 0.95 | 1146 | 77% | G | 1345 | NG | Compar- |
| | | | | | | | | | | | | | | | | ative |
| | | | | | | | | | | | | | | | | Example |
| 16 | H | 14.0 | 63 | 72 | F, P | 1.6 | 1.3 | 9.4 | 9.0 | 0.93 | 1038 | 78% | G | 1232 | G | Example |
| 17 | I | 15.3 | 59 | 73 | F, P | 1.8 | 1.4 | 8.3 | 7.8 | 0.92 | 1014 | 79% | G | 1206 | G | Example |
| 18 | J | 15.0 | 58 | 75 | F, P | 1.6 | 1.2 | 9.4 | 8.8 | 0.91 | 938 | 80%≤ | G | 1135 | G | Example |
| 19 | K | 15.0 | 61 | 83 | F, P | 1.7 | 1.4 | 8.8 | 8.1 | 0.92 | 924 | 80%≤ | G | 1122 | G | Example |
| 20 | L | 15.0 | 60 | 85 | F, P | 1.6 | 1.2 | 9.4 | 8.7 | 0.92 | 1197 | 76% | G | 1406 | G | Example |
| 21 | D | 15.0 | 60 | 54 | F, P, M | 1.6 | 1.2 | 9.4 | 9.2 | 0.92 | 1214 | 63% | NG | 1302 | NG | Compar- |
| | | | | | | | | | | | | | | | | ative |
| | | | | | | | | | | | | | | | | Example |
| 22 | F | 15.0 | 63 | 53 | F, P, M | 1.5 | 1.2 | 10.0 | 9.5 | 0.91 | 1303 | 51% | NG | — | — | Compar- |
| | | | | | | | | | | | | | | | | ative |
| | | | | | | | | | | | | | | | | Example |
| 23 | K | 17.5 | 61 | 84 | F, P | 1.4 | 1.0 | 10.7 | 9.1 | 0.95 | 1037 | 78% | G | 1236 | NG | Compar- |
| | | | | | | | | | | | | | | | | ative |
| | | | | | | | | | | | | | | | | Example |
| 24 | L | 15.0 | 60 | 85 | F, P | 1.4 | 1.0 | 10.7 | 9.3 | 0.93 | 1201 | 76% | G | 1410 | NG | Compar- |
| | | | | | | | | | | | | | | | | ative |
| | | | | | | | | | | | | | | | | Example |
| 25 | H | 13.2 | 63 | 73 | F, P | 1.0 | 1.0 | 15.0 | 12.8 | 0.93 | 872 | 80%≤ | G | 1016 | G | Compar- |
| | | | | | | | | | | | | | | | | ative |
| | | | | | | | | | | | | | | | | Example |
| 26 | J | 13.2 | 58 | 73 | F, P | 1.2 | 1.1 | 12.5 | 11.5 | 0.94 | 793 | 80%≤ | G | 989 | G | Compar- |
| | | | | | | | | | | | | | | | | ative |
| | | | | | | | | | | | | | | | | Example |
| 27 | L | 15.0 | 60 | 96 | P | 1.5 | 1.3 | 10.0 | 11.1 | 0.97 | 1211 | 72% | NG | 1420 | NG | Compar- |
| | | | | | | | | | | | | | | | | ative |
| | | | | | | | | | | | | | | | | Example |
| 28 | F | 17.5 | 63 | 92 | P | 1.5 | 1.1 | 10.0 | 9.6 | 1.05 | 1049 | 73% | NG | 1249 | G | Compar- |
| | | | | | | | | | | | | | | | | ative |
| | | | | | | | | | | | | | | | | Example |

—Description of Table 3—

In the balance structure column, F, P, and M mean proeutectoid ferrite, pearlite, and martensite, respectively.

As shown in Table 3, although a steel wire of each condition of Example having the chemical composition according to the disclosure, wherein the bainite area ratio was (35×[C %]+50)% or more, the balance structure was at least one of proeutectoid ferrite (F) or pearlite (P), AR was 1.4 or more, the ratio of the aspect ratios [surface layer/0.25D] was 1.1 or more, GD was (15/AR) μm or less, the grain size ratio [GD/0.25D] was less than 1.0, and TS was from 900 to 1,500 MPa is a steel wire having a TS of 900 MPa or more, it is excellent in cold workability and also excellent in hydrogen embrittlement resistance when formed into a machine part.

It was possible to manufacture a machine part having a TS of 1,100 MPa or more by cold working a steel wire of each condition in Example.

In contrast to Example, steel wires of conditions 10, 13, and 21 (Comparative Examples) in which the bainite area ratio was less than (35×[C %]+50)% were inferior in cold workability and hydrogen embrittlement resistance when formed into a machine part.

A steel wire of condition 22 (Comparative Example) in which the bainite area ratio was less than (35×[C %]+50)% and which contained martensite in the balance was particularly poor in cold workability, and even a machine part could not be manufactured. For this reason, hydrogen embrittlement resistance of the steel wire of condition 22 could not be evaluated when the wire was formed into a machine part.

The steel wires of conditions 2, 8, and 15 (Comparative Examples) in which the AR was less than 1.4 were inferior in hydrogen embrittlement resistance when formed into a machine part.

Steel wires of conditions 2, 15, 23, and 24 (Comparative Exampls) in which the ratio of the aspect ratios [surface layer/0.25D] was less than 1.1 was inferior in hydrogen embrittlement resistance when formed into a machine part.

Steel wires of conditions 5 and 27 (Comparative Examples) in which the GD was (15/AR) μm or more were inferior in cold workability of the steel wire. In condition 27, the steel was also inferior in hydrogen embrittlement resistance when formed into a machine part.

Steel wires of conditions 5 and 28 (Comparative Examples) in which the ratio [GD/0.25D] of the grain size was 1.0 or more were inferior in cold workability of the steel wire.

For steel wires of conditions 25 and 26 (Comparative Examples) in which the TS was less than 900 MPa, a machine part having a TS of 1,100 MPa or more could not be manufactured.

In a steel wire having a poor cold workability (the critical compression ratio was less than 75%), the frequent occurrence of the process cracking when a machine part was manufactured was high. Further, a machine part manufactured using a steel wire having a poor cold workability (critical compression ratio less than 75%) was inferior in dimensional accuracy.

The disclosure of Japanese Patent Application No. 2016-006378 is hereby incorporated by reference in its entirety.

All Documents, Patent Applications, and technical standards described herein are incorporated by reference herein to the same extent as if each of the Documents, Patent Applications, and technical standards had been specifically and individually indicated to be incorporated by reference.

1-8. (canceled)

9. A steel wire for non-heat treated machine parts, the steel wire having a chemical composition, based on % by mass, of:
C: from 0.20 to 0.40%,
Si: from 0.05 to 0.50%,
Mn: from 0.50 to 2.00%,
Al: from 0.005 to 0.050%,
P: from 0 to 0.030%,
S: from 0 to 0.030%,
N: from 0 to 0.0050%,
Cr: from 0 to 1.00%,
Ti: from 0 to 0.050%,
Nb: from 0 to 0.05%,
V: from 0 to 0.10%,
B: from 0 to 0.0050%,
O: from 0 to 0.0030%, and
a balance being Fe and impurities, wherein:
a microstructure is composed of bainite having an area ratio of (35×[C %]+50)% or more, % by mass of C being defined as [C %], and a balance being at least one of proeutectoid ferrite or pearlite,
in a case in which a cross section parallel to an axial direction of the steel wire and including a central axis is defined as an L cross section, a cross section perpendicular to the axial direction of the steel wire is defined as a C cross section, a diameter of the steel wire is defined as D, an average aspect ratio of a bainite grain measured at a depth of 50 μm from a steel wire surface in the L cross section is defined as AR, and an average grain size of a bainite grain measured at a depth of 50 μm from the steel wire surface in the C cross section is defined as GD, AR is 1.4 or more, (AR)/(an average aspect ratio of a bainite grain measured at a depth of 0.25D from the steel wire surface in the L cross section) is 1.1 or more, GD is (15/AR) μm or less, and (GD)/(an average grain size of a bainite grain measured at a depth of 0.25D from the steel wire surface in the C cross section) is less than 1.0, and
a tensile strength is from 900 to 1,500 MPa.

10. The steel wire for non-heat treated machine parts according to claim 9, containing, based on % by mass, one, or two or more of:
Cr: more than 0 and 1.00% or less,
Ti: more than 0 and 0.050% or less,
Nb: more than 0 and 0.05% or less,
V: more than 0 and 0.10% or less, or
B: more than 0 and 0.0050% or less.

11. The steel wire for non-heat treated machine parts according to claim 9 wherein D is from 3 to 30 mm.

12. The steel wire for non-heat treated machine parts according to claim 10, wherein D is from 3 to 30 mm.

13. The steel wire for non-heat treated machine parts according to claim 9, wherein a critical compression ratio is 75% or more.

14. The steel wire for non-heat treated machine parts according to claim 10, wherein a critical compression ratio is 75% or more.

15. The steel wire for non-heat treated machine parts according to claim 11, wherein a critical compression ratio is 75% or more.

16. The steel wire for non-heat treated machine parts according to claim 12, wherein a critical compression ratio is 75% or more.

17. A non-heat treated machine part, comprising a cylindrical shaft, the non-heat treated machine part having a chemical composition, based on % by mass, of:
C: from 0.20 to 0.40%,
Si: from 0.05 to 0.50%,
Mn: from 0.50 to 2.00%,
Al: from 0.005 to 0.050%,
P: from 0 to 0.030%,
S: from 0 to 0.030%,
N: from 0 to 0.0050%,
Cr: from 0 to 1.00%,
Ti: from 0 to 0.050%,
Nb: from 0 to 0.05%,
V: from 0 to 0.10%,
B: from 0 to 0.0050%,
O: from 0 to 0.0030%, and
a balance being Fe and impurities, wherein:
a microstructure is composed of bainite having an area ratio of (35×[C %]+50)% or more, % by mass of C being defined as [C %], and a balance being at least one of proeutectoid ferrite or pearlite,
in a case in which a cross section parallel to an axial direction of the cylindrical shaft and including a central axis is defined as an L cross section, a cross section perpendicular to the axial direction of the cylindrical shaft is defined as a C cross section, a diameter of the cylindrical shaft is defined as D, an average aspect ratio of a bainite grain measured at a depth of 50 μm from a cylindrical shaft surface in the L cross section is defined as AR, and an average grain size of a bainite grain measured at a depth of 50 um from the cylindrical shaft surface in the C cross section is defined as GD, AR is 1.4 or more, (AR)/(an average aspect ratio of a bainite grain measured at a depth of 0.25D from the cylindrical shaft surface in the L cross section) is 1.1 or more, GD is (15/AR) um or less, and (GD/an average grain size of a bainite grain measured at a depth of 0.25D from the cylindrical shaft surface in the C cross section) is less than 1.0, and a tensile strength of the cylindrical shaft is from 1,100 to 1,500 MPa.

18. The non-heat treated machine part according to claim 17 containing, based on % by mass, one, or two or more of:
Cr: more than 0 and 1.00% or less,
Ti: more than 0 and 0.050% or less,
Nb: more than 0 and 0.05% or less,
V: more than 0 and 0.10% or less, or
B: more than 0 and 0.0050% or less.

19. A non-heat treated machine part, which is a cold-worked product of the steel wire for non-heat treated machine parts according to claim 9, comprising a cylindrical shaft, wherein a tensile strength of the cylindrical shaft is from 1,100 to 1,500 MPa.

20. A non-heat treated machine part, which is a cold-worked product of the steel wire for non-heat treated machine parts according to claim 10, comprising a cylindrical shaft, wherein a tensile strength of the cylindrical shaft is from 1,100 to 1,500 MPa.

21. A non-heat treated machine part, which is a cold-worked product of the steel wire for non-heat treated machine parts according to claim 11, comprising a cylindrical shaft, wherein a tensile strength of the cylindrical shaft is from 1,100 to 1,500 MPa.

22. A non-heat treated machine part, which is a cold-worked product of the steel wire for non-heat treated machine parts according to claim 12, comprising a cylindrical shaft, wherein a tensile strength of the cylindrical shaft is from 1,100 to 1,500 MPa.

23. A non-heat treated machine part, which is a cold-worked product of the steel wire for non-heat treated machine parts according to claim 13 comprising a cylindrical shaft, wherein a tensile strength of the cylindrical shaft is from 1,100 to 1,500 MPa.

24. A non-heat treated machine part, which is a cold-worked product of the steel wire for non-heat treated machine parts according to claim 14 comprising a cylindrical shaft, wherein a tensile strength of the cylindrical shaft is from 1,100 to 1,500 MPa.

25. The non-heat treated machine part according to claim 17, which is a non-heat treated bolt.

26. The non-heat treated machine part according to claim 19, which is a non-heat treated bolt.

27. The non-heat treated machine part according to claim 21, which is a non-heat treated bolt.

28. The non-heat treated machine part according to claim 23, which is a non-heat treated bolt.
